(19) United States
(12) Patent Application Publication
(10) Pub. No.: US 2008/0219901 A1
(43) Pub. Date: Sep. 11, 2008

(54) Cylindrical Steam Reformer Having Integrated Heat Exchanger

(75) Inventors: Young Seek Yoon, Daejeon (KR); Jin Hong Kim, Daejeon (KR); Il Su Kim, Daejeon (KR); Keun Seob Choi, Daejeon (KR)

Correspondence Address: DARBY & DARBY P.C., P.O. BOX 770, Church Street Station, New York, NY, 10008-0770, US

(73) Assignee: SK ENGERGY CO., LTD, SEOUL JONGRO-GU (KR)

(21) Appl. No.: 11/911,016

(22) PCT Filed: Apr. 11, 2006
(86) PCT No.: PCT/KR06/01314

§ 371 Date: Nov. 2, 2007

(30) Foreign Application Priority Data
Apr. 11, 2005 (KR) 10-2005-0030022

(51) Int. Cl. B01J 8/04

(52) U.S. Cl. 422/197

(57) ABSTRACT

Disclosed herein is a cylindrical steam reformer, including a reforming part, a combustion part, an internal heat exchange part, and a steam generation part, which are integrally manufactured into a single reactor, thus forming an optimal heat exchange network leading to optimal performance of the individual parts. In addition, the steam reformer of this invention is designed in a manner such that an upper reactor zone, a middle reactor zone, and a lower reactor zone are removably connected so as to easily supply a catalyst and increase durability, and therefore such a reformer can be mounted in places which are small and require stability, such as hydrogen stations.

### TECHNICAL FIELD

The present invention relates to a cylindrical steam reformer, which can be applied to include fuel cells requiring hydrogen or hydrogen stations for supplying hydrogen to fuel cell vehicles or other similar places, so as to continuously supply hydrogen using natural gas or hydrocarbons.

### BACKGROUND ART

While problems of limitation of the amount of buried fossil fuel and environmental contamination have occurred, a new era of hydrogen energy using hydrogen, which is a harmless clean fuel as an energy source, is predicted to come. However, there presently exist technical and commercial limitations on producing hydrogen from alternative energy as pure clean energy. Thus, hydrogen is intended to be produced as clean fuel having little contamination using conventional fossil fuels, that is, hydrocarbons including natural gas, as an intermediate step.

Such hydrogen has been already used in various industrial fields, such as ammonia synthesis, methanol synthesis, petroleum refining industries including hydrodesulfurization, hydro-treating, or general and refined chemical processes, electronic and semiconductor industries, food and metal processing, etc. In particular, in energy fields, the use of hydrogen has broadened beyond use as a propellant in a space shuttle in which it is difficult to implement an internal combustion engine, to fuels for fuel cells and fuel cell vehicles for use in homes or power plants capable of solving problems of self-supply of power, energy efficiency, and environmental contamination.

To this end, methods of preparing hydrogen, which have been proposed to date, include, for example, steam reforming of fossil fuel (coal, petroleum, natural gas, propane, butane), partial oxidation or autothermal reforming, electrolysis of water, etc. Of these methods, a steam reforming process is regarded as a commercially and economically usable technique.

The steam reforming process is mainly used for production of hydrogen on a large scale. In such a case, a reforming reactor used for the hydrogen production process is designed to be operated under conditions of high pressure (15-25 bar) and high temperature (850° C. or more), thus advantageously preparing hydrogen. However, the steam reforming process suffers because the size of the reactor itself is very large, and thus, a thermal network is difficult to effectively design, resulting in very low efficiency. On the other hand, in the case where the reforming reactor used for the hydrogen production process is designed to have a small or medium size, the manufacture of such a reactor is complicated and the installation cost thereof greatly increases, therefore negating economic benefits.

In addition, when the device is designed to be large in terms of stable operation, a reforming reactor, high-temperature and low-temperature water-gas shift reactor, and a steam generator necessary for respective unit processes should be separately mounted, and an external heat exchanger for heat exchange of the above reactors should be additionally provided, thereby enlarging the whole structure of the device. Consequently, due to heat loss in the heat exchanger and the pipe connected to each reactor, it is difficult to realize high heat efficiency.

With the goal of overcoming such problems of small and medium sized reformers, various thorough attempts have been made to partially combine respective unit processes, develop a catalyst suitable for small and medium sized systems, optimize a mutual heat exchange network through heat flow analysis, simplify the structure of the reformer so as to increase processibility and productivity, and integrate the reactors while reducing the sizes thereof in order to decrease initial operation time and heat loss, resulting in increased heat efficiency.

In this regard, a conventional small or medium sized reformer is shown in FIG. 1. As shown in this drawing, the conventional reformer requires installation of a large external heat exchanger to the outside thereof so as to help increase the temperature of feed/steam to a temperature (500-700° C.) appropriate for a steam reforming reactor using high-temperature combustion exhaust gas discharged after supplying heat of combustion gas produced in a burner to a reforming reactor for a reforming reaction in the reforming reactor. In this case, however, since the heat exchanger functions to exchange heat of the combustion exhaust gas at 500° C. or more, it should be suitable for use at high temperatures and should have a relatively large size, causing problems related to cost and size. Particularly, the increase in heat efficiency is limited, attributable to heat insulating problems of the heat exchanger itself and the heat loss from pipes.

Further, in order to remove carbon monoxide from high-temperature reformate, including reformed hydrogen, carbon monoxide and carbon dioxide steam, when the reformate is supplied to the water-gas shift reactor, another external heat exchanger should be additionally provided to decrease the temperature of reformate to 400-500° C. to be suitable for a high temperature shift reaction. As such, however, the problem of material for the heat exchanger occurs, along with a problem of heat transfer efficiency when using air, which is the fuel for the burner, as the heat exchange medium, and thus it is difficult to minimize the heat loss.

Accordingly, to solve the above problems, there is an urgent need for a steam reformer capable of minimizing heat loss occurring in the heat exchangers and pipes and optimizing the mounting space.

### DISCLOSURE OF INVENTION

### Technical Problem

Therefore, it is an object of the present invention to provide a cylindrical steam reformer, comprising a reforming part, a combustion part, an internal heat exchange part, and a steam generation part, which are integrally manufactured into a single reactor, thus forming an optimal heat exchange network leading to optimal performance of the individual parts.

Another object of the present invention is to provide a cylindrical steam reformer, in which an internal heat exchange part is formed, thus minimizing the necessary capacity of an additional external heat exchanger and minimizing the heat loss attributable to peripheral devices, resulting in improved heat efficiency compared to conventional commercial hydrogen preparation plants.

A further object of the present invention is to provide a cylindrical steam reformer, which can be applied which are small and require stability, such as hydrogen stations, by designing a reactor comprising an upper reactor zone, a middle reactor zone, and a lower reactor zone, which are removably connected so as to enable easy supply of a catalyst and increase durability.

### Technical Solution

In order to achieve the above objects, the present invention provides a cylindrical steam reformer having an integrated heat exchanger, comprising a reactor, the reactor including an upper reactor zone having an internal heat exchange part, a middle reactor zone connected to the upper reactor zone and having a combustion part, a steam generation part, and a reforming part, and a lower reactor zone constituting the lower surface of the middle reactor zone, in which the upper reactor zone, the middle reactor zone, and the lower reactor zone are removably connected, thereby forming the heat transfer path in the internal heat exchange part of the upper reactor zone and in the middle reactor zone so as to alleviate the effect of thermal expansion on the reactor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view of a conventional steam reformer;

FIG. 2 is a schematic view of a steam reformer, according to the present invention;

FIG. 3 is a view showing the inner structure of a cylindrical steam reformer, according to the present invention; and

FIGS. 4 to 6 are cross-sectional views showing individual parts of the cylindrical steam reformer, according to the present invention.

### BEST MODE FOR CARRYING OUT THE INVENTION

Hereinafter, a detailed description will be given of the present invention, with reference to the appended drawings.

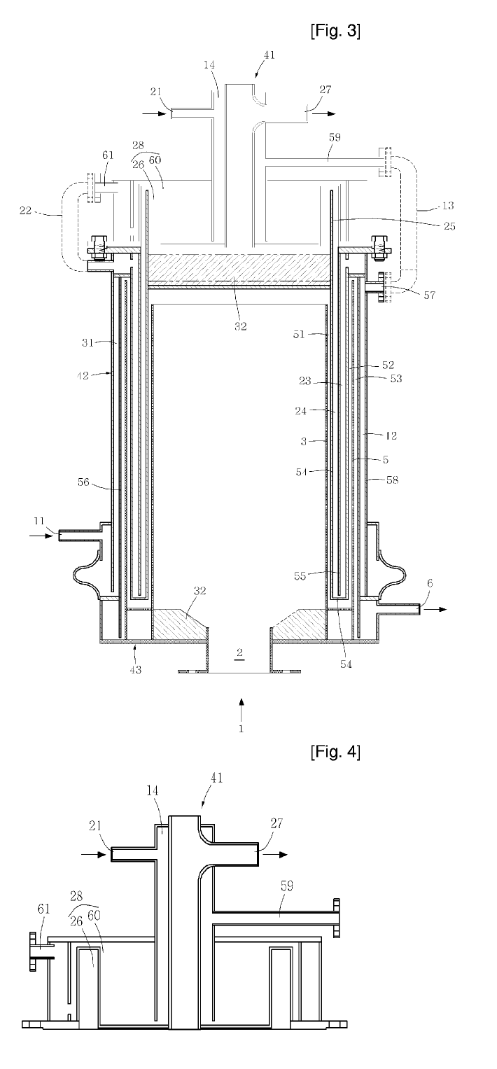

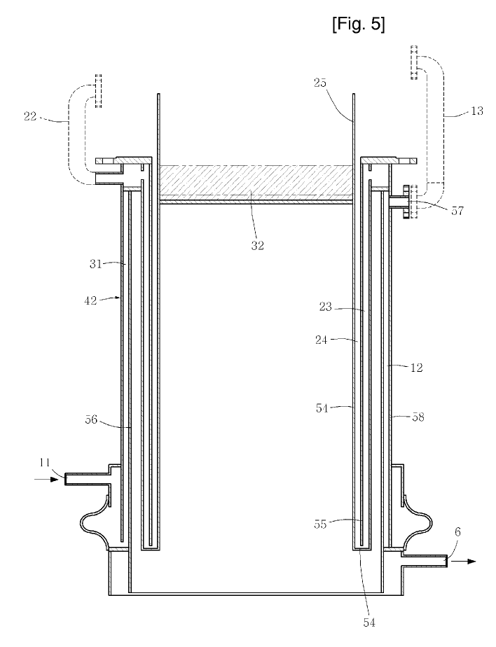

FIG. 2 schematically shows a steam reformer of the present invention, and FIG. 3 shows the inner structure of the cylindrical steam reformer of the present invention.

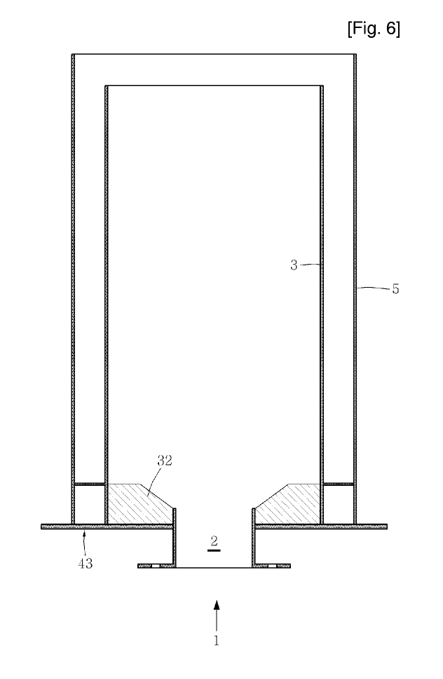

FIGS. 4 to 6 show the inner structure of each of an upper reactor zone, a middle reactor zone, and a lower reactor zone of the steam reformer, according to the present invention.

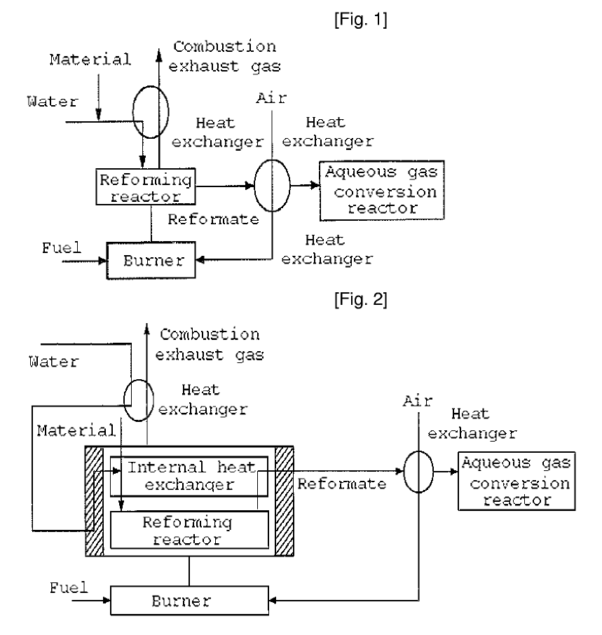

The cylindrical steam reformer according to the present invention is schematically shown in FIG. 2. As is apparent from this drawing, the steam reformer of the present invention is characterized by including an internal heat exchange part, a combustion part, a steam generation part, and a reforming part in a single reactor. That is, the cylindrical steam reformer of the present invention is designed to provide the internal heat exchange part in the reactor so as to minimize the size of the external heat exchanger necessary for the conventional steam reformer shown in FIG. 1 and realize minimum heat loss in pipes thereof, and to improve the flow path of combustion gas so as to enable the use of only a low-temperature external heat exchanger having a small capacity.

FIG. 3 is a cross-sectional view showing the structure of the cylindrical steam reformer having an integrated heat exchanger, according to the present invention. FIGS. 4 to 6 are cross-sectional views of individual parts of the steam reformer of FIG. 3. That is, the cylindrical steam reformer of the present invention is characterized in that the internal heat exchange part is provided therein, the upper reactor zone, the middle reactor zone, and the lower reactor zone of the steam reformer are removably connected in order to enable convenient assembly or disassembly thereof, and also, filler or a reforming catalyst to be placed in the flow path of the reformer may be easily supplied and replaced.

As shown in the drawings, the cylindrical steam reformer having an integrated heat exchanger, according to the present invention, comprises a reactor, which is composed of an upper reactor zone 41 having an internal heat exchange part 28, a middle reactor zone 42 connected to the upper reactor zone 41 and having a combustion part, a steam generation part, and a reforming part, and a lower reactor zone 43 constituting the lower surface of the middle reactor zone 42. Such individual parts of the reactor are described with reference to FIGS. 3 and 4 to 6.

FIG. 4 is a cross-sectional view showing the upper reactor zone of the steam reformer of the present invention. The upper reactor zone 41 includes two flow paths, one flow path of which functions to transfer feed/steam, the other flow path of which functions to transfer reformate formed in the middle reactor zone 42 prior to being externally discharged. The two flow paths thus formed are positioned adjacent to each other, and the feed/steam and the reformate flowing in the above flow paths have different temperatures. Thus, when the feed/steam and the reformate are passed through the respective flow paths, heat exchange therebetween takes place, and therefore the two flow paths function as a heat exchanger. That is, the internal heat exchange part 28 provided in the upper reactor zone 41 consists of a feed/steam flow path 60 and a reformate flow path 26.

The feed/steam flow part includes a feed/steam mixing pipe 14 for mixing material externally supplied via a material inlet 21 with steam supplied via a steam inlet 59 from the steam generation part of the middle reactor zone 42, a feed/steam flow path 60 for transferring the feed/steam mixed in the feed/steam mixing pipe 14, and a feed/steam outlet 61 for discharging the feed/steam having exchanged heat with the reformate through the feed/steam flow path 60 into the reforming part of the middle reactor zone 42.

The reformate flow part includes the reformate flow path 26 for transferring the reformate formed in the reforming part of the middle reactor zone 42, and a low-temperature reformate outlet 27 for externally discharging the reformate having exchanged heat with the feed/steam through the reformate flow path 26.

As shown in FIGS. 4 and 5, in the heat transfer path of the internal heat exchange part 28 including the feed/steam flow path 60 and the reformate flow path 26, the reformate flow path 26 is formed by connecting the upper reactor zone 41 to the middle reactor zone 42. Preferably, the above heat transfer path may be designed to have a zigzag shape by controlling the number of plates constituting it so as to realize high heat exchange efficiency. Further, metal porous filler is charged in the internal heat exchange part 28, thereby assuring a maximum heat transfer area for a minimum volume. The charged filler is preferably composed of metal having high corrosion resistance, and is in mesh, fiber, or knit form in order to prevent a pressure drop in the pipe.

With reference to FIGS. 3 and 5, the middle reactor zone 42 includes the combustion part, the steam generation part, and the reforming part.

In the middle reactor zone 42 of the cylindrical steam reformer, the combustion part, functioning to supply a predetermined amount of heat required for a reforming reaction, is composed of a burner 2 for burning air/fuel supplied via an air/fuel inlet 1, a first combustion gas flow path 51 and a second combustion gas flow path 52 formed for surrounding the reforming part so as to exchange heat between the combustion gas produced in the burner 2 and the reforming part, a third combustion gas flow path 53 for exchanging heat between the combustion gas passed through the second combustion gas flow path 52 and the steam generation part, and an exhaust gas outlet 6 for externally discharging the combustion gas passed through the third combustion gas flow path 53.

As such, the first combustion gas flow path 51 is positioned between a combustion pipe 3 and a reforming pipe 54, and the second combustion gas flow path 52 is positioned between the reforming pipe 54 and a combustion gas separation pipe 5, in order to surround the reforming pipe 54. In this way, the reforming part is surrounded by the first combustion gas flow path 51 and the second combustion gas flow path 52, so that heat exchange between the combustion gas and the reforming part may occur. Therefore, heat required for the reforming reaction may be supplied from the combustion gas. As such, the combustion pipe 3 functions to prevent partial overheating of flame from the burner and to guide the combustion gas into the first combustion gas flow path 51.

Further, the combustion gas passed through the second combustion gas flow path 52 is allowed to pass through the third combustion gas flow path 53 as a flow path formed by the combustion gas separation pipe 5. The third combustion gas flow path 53 is defined by a space between the combustion gas separation pipe 5 and the steam generation pipe 56 so as to realize heat exchange with the steam generation part. As such, the combustion gas separation pipe 5 is provided such that the combustion gas passed through the first combustion gas flow path 51 is dividedly supplied into two flow paths, that is, the second combustion gas flow path 52 and the third combustion gas flow path 53. Thereby, heat generated from the combustion gas is uniformly distributed to the two flow paths comprising the second combustion gas flow path 52 and the third combustion gas flow path 53 so as to minimize heat loss, therefore realizing optimal heat exchange and preventing a drastic drop in the temperature of the combustion gas. The combustion gas passed through the third combustion gas flow path 53 is subsequently discharged through the exhaust gas outlet 6, and thus functions to preheat water flowing to the inner portion of the reformer in the external heat exchanger.

In the middle reactor zone 42 of the cylindrical steam reformer of the present invention, the steam generation part is used to supply steam to the reformer, and includes a steam inlet 11 for supplying steam in a combined gas-liquid state or a gaseous state having externally increased temperature, a steam generation path 12 for increasing the steam supplied via the steam inlet 11 to a predetermined temperature through heat exchange with the combustion gas passing through the third combustion gas flow path 53, and a steam outlet 57 for discharging the steam passed through the steam generation path 12 to the upper reactor zone 41.

As such, the steam generation path 12 is defined by a space between the body 58 of the middle reactor zone 42 and the steam generation pipe 56, and is simply filled with the metal porous filler, thereby assuring the maximum heat transfer area for the minimum volume. Comparing with a conventional reactor, around which a heat exchange tube is wound, the reactor of the present invention is easy to manufacture. The filler is preferably composed of metal having high corrosion resistance, and is in mesh, fiber or knit form to prevent a pressure drop in the pipe. More preferably, useful is stainless steel, which does not cause deformation or thermal expansion at high temperatures or corrode due to surface oxidation.

The steam thus generated is discharged via the steam outlet 57, and therefore may be supplied to the upper reactor zone 41 through the steam flow path 13 serving to connect the upper reactor zone 41 to the middle reactor zone 42. Since the steam flow path 13 is connected to the upper reactor zone 41 and the middle reactor zone 42 by predetermined flanges, it may be easily assembled or disassembled.

In the middle reactor zone 42, the reforming part, functioning to produce hydrogen from externally supplied feed/steam, includes two flow paths comprising a high-temperature feed/steam path 23 and a reforming path 24 formed by the reforming separation pipe 55 that is provided in a space defined by the reforming pipe 54, and a high-temperature reformate discharge pipe 25. As such, the high-temperature feed/steam path 23 functions to preheat the low-temperature feed/steam passed through the internal heat exchange part 28 provided in the upper reactor zone 41 of the present invention to a predetermined temperature before entering the reforming path 24 through heat exchange with the second combustion gas flow path 52 surrounding the reforming pipe 54. The reforming path 24 functions to reform the high-temperature feed/steam passed through the high-temperature feed/steam path 23 using the reforming catalyst to be converted into reformate. In such a case, the high-temperature feed/steam path 23 is also filled with the metal porous filler, as is the steam generation path 12, thus assuring an effective heat transfer area.

In the reforming path 24, an Ni-based steam reforming catalyst or an Ni-based steam reforming catalyst containing at least 0.01 wt % of precious metal such as Pt or Ru is charged. The diameter of the reforming catalyst is preferably ⅓ to 1/10 the diameter of the reforming path 24, in consideration of the pressure drop in the pipe and the reactivity therein.

The lower reactor zone 43 of the cylindrical steam reformer of the present invention is shown in FIG. 6. The lower reactor zone 43, constituting the lower surface of the middle reactor zone 42, includes the combustion pipe 3 and the combustion gas separation pipe 5. That is, the lower reactor zone 43 is connected to the middle reactor zone 42, thereby forming a predetermined flow path. In this way, the additional formation of the lower reactor zone 43 results in no interference between the middle reactor zone 42 and the lower reactor zone 43 upon thermal expansion caused by the operation of the reformer.

The combustion pipe 3 and the combustion gas separation pipe 5 defining the heat transfer path are connected to the lower reactor zone 43 and are preferably formed of metal that is easily prepared, or alternatively may be formed of ceramic material or material having a thermal transfer coefficient similar to that of the ceramic material in order to prevent conductive heat transfer. Although the lower reactor zone 43 is integrated with the combustion pipe 3 and with the combustion gas separation pipe 5, the present invention is not limited thereto. In FIG. 3, the reference number 32 designates heat insulating material, which is used to prevent flame, resulting from combustion in the middle reactor zone 42, from affecting the other reaction procedures.

In the present invention, the cylindrical steam reformer having a heat exchanger integrated therewith is composed of the upper reactor zone 41, the middle reactor zone 42, and the lower reactor zone 43, which are separately provided or are connected to one another using flanges. In particular, even upon thermal expansion of metal caused by rapid start-up operation, the reactor is structured such that the individual reactor zones do not interfere with one another. Further, the upper reactor zone 41 is designed to be easily removed from the middle reactor zone 42, whereby the catalyst inlet of the reforming part is opened upon removal of each reactor zone, thus efficiently supplying the catalyst.

In addition, the heat transfer path of the middle reactor zone 42 is effectively arranged so that the heat exchange of the combustion part, the reforming part, and the steam generation part is efficiently realized, leading to an optimal heat exchange network.

The operation of the cylindrical steam reformer having an integrated heat exchanger of the present invention is described in conjunction with FIGS. 2 and 3.

FIG. 3 shows the inner structure of the cylindrical reformer of the present invention. In the present invention, the operation of the cylindrical reformer is largely divided into combustion and reforming processes.

As shown in FIGS. 2 and 3, in the combustion process, air to be supplied to the burner 2 of the reactor is preheated in the external heat exchanger by the reformate discharged via the low-temperature reformate outlet 27 of the upper reactor zone 41, and is then supplied via the air/fuel inlet 1. The air thus supplied is burned along with fuel in the combustion pipe 3 via the burner 2, thus generating heat. The combustion gas thus generated exchanges heat with the reforming part and the steam generation part while passing through the first combustion gas flow path 51, the second combustion gas flow path 52, and the third combustion gas flow path 53. That is, the combustion gas functions to increase the temperature of the steam passing through the steam generation part while maintaining the temperature of the reforming part through heat exchange with the reforming part. Thereafter, the combustion gas is externally discharged via the combustion exhaust gas outlet 6, thereby completing the combustion process.

Referring to FIGS. 2 and 3, the reforming process of the present invention is described. For the reforming reaction, steam must be supplied into the reformer of the present invention. To this end, water, which is externally supplied, is converted into steam in the low-temperature external heat exchanger, having a small capacity, by heat of the exhaust gas discharged through the above combustion process, after which such steam is supplied into the reactor via the steam inlet 11 of the steam reformer. The steam thus supplied recovers heat of the combustion gas through heat exchange with the third combustion gas flow path 53 adjacent to the steam generation path 12 while passing through the steam generation path 12 and is then supplied into the upper reactor zone 41 through the steam outlet 57 and the steam flow path 13 and then through the steam inlet 59 provided in the upper reactor zone 41. The supplied steam is mixed with the material supplied via the material inlet 21 in the feed/steam mixing pipe 14 and is then transferred via the feed/steam flow path 60.

As such, the feed/steam flowing through the feed/steam flow path 60 primarily recovers heat through heat exchange with the reformate flowing via the reformate flow path 26 adjacent to the feed/steam flow path 60. Subsequently, the feed/steam are supplied into the middle reactor zone 42 through the feed/steam outlet 61 and then through the low-temperature feed/steam path 22 acting to connect the upper reactor zone 41 and the middle reactor zone 42. As such, the low-temperature feed/steam supplied into the middle reactor zone 42 should be preheated to a temperature suitable for the reforming reaction before the reforming reaction occurs. The preheating process is accomplished in a manner such that the low-temperature feed/steam exchange heat with the second combustion gas flow path 52 adjacent to the high-temperature feed/steam path 23 while passing through the high-temperature feed/steam path 23, thereby secondarily recovering heat from the combustion gas. Then, the feed/steam are supplied into the reforming path 24 to undergo the reforming reaction in the presence of the reforming catalyst. After the reforming reaction, the feed/steam are converted into reformate comprising hydrogen, carbon monoxide, carbon dioxide, unconverted hydrocarbon feed, and excess water.

The reformate thus obtained is transferred to the upper reactor zone 41 via the high-temperature reformate discharge pipe 25, and is then discharged via the low-temperature reformate outlet 27 via the reformate flow path 26. As such, the reformate flow path 26 is adjacent to the feed/steam flow path 60, and thus heat may be supplied to the feed/steam through heat exchange therebetween. The reformate discharged through the low-temperature reformate outlet 27 is supplied into the water-gas shift reactor through the additional external heat exchanger, thereby achieving the reforming process of the present invention.

In some cases, the amount of fossil fuel for the combustion can be reduced by using stak off-gas or PSA off-gas as fuel for burner. During the initial heating-up procedure, the use of the fossil as fuel for burner is inevitable. However, once the reformer starts to steadily produce hydrogen in normal operation condition, the reformate can be delivered into fuel cell stack, and the stack starts to generate electricity by using hydrogen included in the reformate. The gas stream evolved from fuel cell stack after consuming appropriate amount of hydrogen for generating electricity, so called, stack-off gas, still contains some extent of hydrogen, carbon monoxide, carbon dioxide, and moisture and can be recycled into burner and used as fuel for the reformer. For another instance, the reformate from reformer could be purified by using PSA (pressure swing adsorption) equipment in order to produce hydrogen in high purity, and the remaining gas (PSA off-gas) is recycled and used as a fuel for burner, and consequently, it can increase the total heat efficiency.

### INDUSTRIAL APPLICABILITY

As described hereinbefore, the present invention provides a cylindrical steam reformer having an integrated heat exchanger, which can continuously supply hydrogen to fuel cell systems or fuel cell vehicles requiring hydrogen by reducing the size of a hydrogen generator, typical of a conventional large plant, and then applying it to fuel cells or hydrogen stations. According to the present invention, the cylindrical steam reformer comprises a reforming part, a combustion part, an internal heat exchange part, and a steam generation part, which are integrally manufactured into a single reactor, thus forming an optimal heat exchange network leading to optimal performance of the individual parts. Thereby, heat loss is minimized and optimal heat exchange efficiency is realized. In addition, the steam reformer of the present invention is designed to simplify fluid flow so as to minimize stagnant portions and also to have high efficiency, stability and durability, in consideration of the expansion and contraction of the material of the high-temperature reactor.

In the case where the steam reformer of the present invention is mounted in a space which has a small foot-print and requires safe and stabile operation, such as a hydrogen station, heat exchange efficiency is maximized and thus total heat efficiency increases, resulting in decreased hydrogen preparation cost. Further, a sufficiently efficient thermal network can be realized even using a low-temperature external heat exchanger having a small capacity while minimizing the capacity of an external heat exchanger having a limited size. Thereby, additional material problems can be overcome, therefore improving the commercial usability of the hydrogen station.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A cylindrical steam reformer having an integrated heat exchanger, comprising a reactor, the reactor including:
an upper reactor zone having an internal heat exchange part;
a middle reactor zone connected to the upper reactor zone and having a combustion part, a steam generation part, and a reforming part; and
a lower reactor zone constituting a lower surface of the middle reactor zone.

2. The reformer according to claim 1, wherein the upper reactor zone comprises two flow paths for transferring feed/steam and reformate, respectively, in which the two flow paths are adjacent to each other for heat exchange therebetween and thus constitute the internal heat exchange part capable of controlling a heat exchange area and gas flow by adjusting a number and a structure of plates used for the heat exchange.

3. The reformer according to claim 1, wherein the combustion part comprises:
a burner for burning air/fuel supplied via an air/fuel inlet;
a first combustion gas flow path and a second combustion gas flow path formed for surrounding the reforming part in order to exchange heat between combustion gas produced in the burner and the reforming part;
a third combustion gas flow path for exchanging heat between the combustion gas passed through the second combustion gas flow path and the steam generation part; and
a combustion exhaust gas outlet for externally discharging the combustion gas passed through the third combustion gas flow path.

4. The reformer according to claim 1, wherein the steam generation part comprises:
a steam inlet for externally supplying steam;
a steam generation path for exchanging heat between the steam supplied via the steam inlet and the combustion gas passed through the third combustion gas flow path; and
a steam outlet for discharging the steam passed through the steam generation path to the upper reactor zone.

5. The reformer according to claim 1, wherein the reforming part comprises a high-temperature feed/steam path and a reforming path, as two flow paths formed by a reforming separation pipe provided in a space defined by the reforming pipe, and a high-temperature reformate discharge pipe, in which
the high-temperature feed/steam path functions to exchange heat between the feed/steam, supplied after having passed through the internal heat exchange part provided in the upper reactor zone, and the second combustion gas flow path surrounding the reforming pipe, and
the reforming path functions to convert the high-temperature feed/steam passed through the high-temperature feed/steam path into reformate via a reforming reaction.

6. The reformer according to claim 1, wherein the internal heat exchange part and steam generation path of the steam generation part are filled with porous metal filler in order to assure a maximum heat transfer area for a minimum volume.

7. The reformer according to claim 6, wherein the filler comprises metal having high corrosion resistance and is in mesh, fiber or knit form in order to prevent pressure drop in a pipe.

8. The reformer according to claim 1, wherein the upper reactor zone, the middle reactor zone, and the lower reactor zone are removably connected, and a heat transfer path is formed in the upper reactor zone and the middle reactor zone by connecting the upper reactor zone, the middle reactor zone, and the lower reactor zone, thus alleviating an effect of thermal expansion of metal on the reactor during rapid start-up operation.
